(19) United States
(12) Patent Application Publication
(10) Pub. No.: US 2011/0293878 A1
(43) Pub. Date: Dec. 1, 2011

(54) RELEASABLE PROTECTIVE LAYER ON A GASKET

(75) Inventors: Michael McManus, Marion, NY (US); Sherwin Damdar, Rochester, NY (US)

(73) Assignee: GARLOCK SEALING TECHNOLOGIES, LLC, Palmyra, NY (US)

(21) Appl. No.: 12/788,156

(22) Filed: May 26, 2010

(51) Int. Cl. B32B 7/06; B32B 37/24

(52) U.S. Cl. 428/98; 156/242

(57) ABSTRACT

Gasket materials having releasable protective layers formed thereon and method of making the same are disclosed. The releasable protective layers provided added strength to the gasket materials to help prevent cracks and chips in the gasket materials that can occur during handling, transporting, and cutting of gasket material. The protective layers can include releasing agent to ensure the protective layers can be removed from the gasket materials prior to being used.

### BACKGROUND

Gasket materials are often manufactured in large sheets that can subsequently be cut into a variety of sizes and shapes as desired by the end user. These sheets can be made from any of a variety of gasket materials, such as graphite or compressed fibers. However, several problems can arise with sheets of gasket materials. For example, sheets of gasket materials can be fragile, especially when the sheet is made from low tensile strength gasket material. The fragility of the sheets of gasket materials tend to make the sheets prone to cracking and chipping during transportation and handling of the sheets. Cutting the gasket sheets to the desired size can also lead to cracking and chipping due to the fragility of the sheets. Furthermore, sheets of gasket materials often fail to provide a manner for easily marking the sheets with information, such as type of gasket material and installation date, without cracking or damaging the sheets.

U.S. Pat. No. 2,597,976 discussed the use of protective layers on cut gasket materials, but it is limited in several respects. Firstly, the '976 patent only contemplates the use of protective layers on gaskets formed of rubber or rubber-like materials. Additionally, as noted previously, the protective coatings in the '976 patent are applied to gaskets which have already been cut to their desired shape and size, thus meaning that the protective layers are not contemplated for uncut gasket sheets. Further still, the protective layers in the '976 patent are designed to protect the gaskets from fluid during use, meaning that the gaskets are installed with the protective layers still adhered thereto. Finally, the protective layers in the '976 patent are disposed on the inner diameter wall of the gasket, rather than solely on the flat opposing surfaces, resulting in the need for additional protective layer material and more complicated processes for disposing the protective layers on the gaskets.

For these and other reasons, a need exists for gasket materials with improved protective layers.

### SUMMARY

In some embodiments, a process for adhering one or more protective layers to a gasket material is disclosed. The process includes providing an undensified gasket material having a first surface and a second surface opposite the first surface. The process also includes disposing a first protective layer on the first surface and disposing a second protective layer on the second surface. The process also includes subjecting the gasket material to densification tooling. The process also includes separating the gasket material from the densification tooling.

In some embodiments, a coated gasket material is disclosed. The coated gasket material include a gasket material having a first surface and a second surface. The coated gasket material further includes a first protective layer and a second protective layer, each of the protective layers having a gasket material surface and a densification tooling surface. The first protective layer is disposed on the first surface of the gasket material such that the gasket material surface of the first protective layer faces the first surface of the gasket material. The second protective layer is disposed on the second surface of the gasket material such that the gasket material surface of the second protective layer faces the second surface of the gasket material. The gasket material surface and the densification tooling surface of each of the first protective layer and the second protective layer are treated with releasing agent, although the densification tooling surface is treated with more releasing agent than the gasket material surface.

Embodiments of the gasket materials summarized above and formed by embodiments of the process summarized above overcome many of the problems associated with sheet gasket material described previously. The protective layers formed on the surfaces of the gasket material protect the gasket material from chipping, cracking, or otherwise being damaged during handling, transporting, and cutting of the gasket material. Additionally, the protective layers allow for the gasket material to be branded with important information regarding the gasket material. Finally, the protective layers can be peeled off of the gasket material prior to installing or using the gasket material

### BRIEF DESCRIPTION OF THE DRAWINGS

The accompanying drawing illustrates exemplary embodiments and is a part of the specification. Together with the following description, the drawing demonstrates and explains various principles of the instant disclosure.

FIG. 1 shows a perspective view of the layers of a gasket material having protective layers adhered thereto as disclosed herein; and

FIG. 2 is a flow chart illustrating an exemplary methodology of forming the protective layer and gasket material.

Throughout the drawing, identical reference characters and descriptions indicate similar, but not necessarily identical, elements. While the exemplary embodiments described herein are susceptible to various modifications and alternative forms, specific embodiments have been shown by way of example in the drawing and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

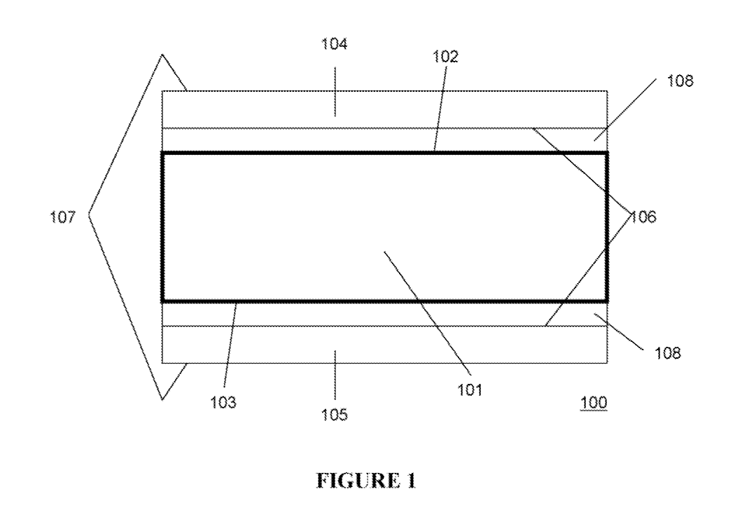

With reference to FIG. 1, a coated gasket material 100 includes a gasket material 101 having a first surface 102 and a second surface 103 opposite the first surface 102, a first protective layer disposed 104 on the first surface 102, and a second protective layer disposed 105 on the second surface 103. The first protective layer 104 and the second protective layer 105 are each releasably adhered to the gasket material 101. In this manner, the first protective layer 104 and the second protective layer 105 will adhere to the gasket material 101 under normal conditions, while also allowing for the removal of the first protective layer 104 and the second protective layer 105 prior to, e.g., installation of the gasket material 101. The first protective layer 104 and the second protective layer 105 provide protection and strength to the gasket material 101 to help prevent chipping and cracking of the gasket material 101 during handling, cutting, and transportation. Additionally, the first protective layer 104 and the second protective layer 105 can be easily peeled off of the gasket material 101, such as manually by an individual prior to installation of the gasket material 101.

Any suitable gasket material can be used for gasket material 101. Exemplary gasket materials include graphite, compressed fiber, or a combination of the two. The gasket material can also be highly filled or low binder gasket materials. In some embodiments, the gasket material is a fragile gasket material. Fragile gasket materials can include any gasket materials having a tensile strength lower than 2000 psi. Fragile gasket materials can include those gasket materials already including some type of reinforcement but which still have a tensile strength lower than 2000 psi. The form of the gasket material 101 is also not limited. For example, the gasket material 101 can be a gasket material sheet. Gasket material already cut into the desired shape and size can also be used for gasket material 101. The thickness of the gasket material 101 can be selected according to the manner in which the gasket material 101 is to be used and is therefore not limited. In some embodiments, the gasket material 101 has thickness in the range for from about 1/64 inches to about ¼ inches.

As noted above, the gasket material 101 includes a first surface 102 and a second surface 103 opposite the first surface 102. The first surface 102 and the second surface 103 are typically planar and aligned in parallel to one another, although the surfaces can have other configurations.

The first protective layer 104 and second protective layer 105 can be made from any material suitable for providing strength and protection to the gasket material 101. In some embodiments, the first protective layer 104 and the second protective layer 105 are made from a polymer material capable of withstanding a densification process. In some embodiments, the material of the first protective layer 104 and the second protective layer 105 comprises polyethylene terephthalate (PET) (e.g., Hostaphan™, Melinex™, and Mylar™), polstyrene (PS), polyethelene (e.g., Tyvek™), polyethylene naphthalate (PEN), polycarbonate, and polyvinyl chloride (IUPAC or PVC). The material of the first protective layer 104 can be the same material or a different material as is used for the second protective layer 105.

The protective layers can be adhered to the gasket material by mechanical means, such as through pressing, calendaring or another mode of densification. The protective layers can also be adhered chemically or thermally to the gasket material. Any combination of physical, chemical, or thermal adherence can be used to adhere the protective layers to the gasket material.

As noted above, the first protective layer 104 is disposed on the first surface 102 of the gasket material 101 and the second protective layer 105 is disposed on the second surface 103 of the gasket material 101. Generally speaking, the first protective layer 104 and the second protective layer 105 are coextensive with the first surface 102 and the second surface 103 of the gasket material 101. However, the first protective layer 104 and the second protective layer 105 can be smaller or larger than the first surface 102 and second surface 103.

In some embodiments, the protective layers 104/105 are porous. In some embodiments, the protective layers are made from polymers that are breathable (e.g., Gore-Tex™ and Tyvek™). Breathable polymers allow water vapor to escape but not liquid water. Breathable protective layers can be useful in cases where the gasket material is stored in a humid environment but still requires protection from liquid being poured on the gasket material.

The thickness of the first protective layer 104 and the second protective layer 105 can be any suitable thickness that provides protection and strength to the gasket material 101. In some embodiments, the thickness of the first protective layer 104 and the second protective layer 105 ranges from about 0.001 inches to about 0.020 inches. The thickness of the first protective layer 104 and the second protective layer 105 is generally consistent, although variations in thickness throughout the first protective layer 104 and the second protective layer 105 are also possible (i.e., thicker towards the middle of the protective layers and thinner at the edges of the protective layers). The thickness of the first protective layer 104 can be the same or different as the thickness of the second protective layer 105. It should also be noted that multiple layers of the protective layer material may be disposed on the surfaces of the gasket material 101.

Each of the first protective layer 104 and the second protective layer 105 includes a gasket material surface 106 and a densification tooling surface 107 opposite the gasket material surface 106. The gasket material surface 106 and the densification tooling surface 107 are generally planar and are aligned parallel to one another. When the first protective layer 104 and the second protective layer 105 are disposed on the first surface 102 and the second surface 103, respectively, the gasket material surfaces 106 of the first protective layer 104 faces the first surface 102 and the gasket material surface 106 of the second protective layer 105 faces the second surface 103.

The gasket material surface 106 and the densification tooling surface 107 of each of the first protective layer 104 and the second protective layer 105 can each be treated with a releasing agent. The releasing agent allows the protective layers to be releasably adhered to the first surface 102 and the second surface 103 of the gasket material 101. Any suitable releasing agent can be used on the first protective layer 104 and the second protective layer 105. In some embodiments, the releasing agent can be selected from polymer releasing agents, organic non-polymer releasing agents, and inorganic non-polymer releasing agents. Any suitable polymer releasing agents known to those of ordinary skill in the art can be used. Examples of suitable polymer releasing agents include, but are not limited to, polysiloxane, methyl silicone oil, low molecular weight polyethylene, polyethylene glycol, epoxy derivatives, and fluorine compounds (such as PTFE). Any suitable organic non-polymer releasing agents known to those of ordinary skill in the art can be used. Examples of suitable organic non-polymer releasing agents include, but are not limited to, graphite, fatty acid soap (e.g., sodium soap and zinc soap), fatty acid, paraffin, white oil, and Vaseline. Any suitable inorganic non-polymer releasing agents known to those of ordinary skill in the art can be used. Examples of suitable inorganic non-polymer releasing agents include, but are note limited to, hydrous magnesium silicate (talc), boron nitride, mica, and molybdenum disulfide. The same releasing agent can be used on the both the protective layers or different releasing agents can be used on each protective layer. Similarly, the same releasing agent can be used on either side of each protective layer, or different releasing agents can be used on either side of each protective layer.

Treating the protective layers 104/105 with releasing agent will create a releasing agent layer 108 on the protective layers 104/105. Accordingly, in instances where releasing agent is used, the releasing agent layer 108 serves as an intermediate layer between the protective layers 104/105 and the gasket material 101. In other words, the protective layers 104/105 do not directly contact the gasket material 101 when the releasing agent is used. The releasing agent layer 108 can adhere to the protective layers 104/105 when the protective layers 104/105 are removed, meaning that no releasing agent remains on the gasket material 101 after the protective layers 104/105 are removed. The releasing agent can also adhere to the gasket material 101 when the protective layers 104/105 are removed, meaning that releasing agent remains on the gasket material 101 after the protective layers 104/105 are removed from the gasket material 101. The releasing agent can also adhere to both the gasket material 101 and the protective layers 104/105, meaning that some releasing agent is present on both the protective layers 104/105 and the gasket material 101 after the protective layers 104/105 are removed from the gasket material 101.

Any suitable amount of releasing agent may be used on the different sides of the first protective layer 104 and the second protective layer 105. Preferably, the amount of releasing agent used on the gasket material side 106 of the first protective layer 104 and the second protective layer 105 is not so much releasing agent as to prevent the first protective layer 104 and the second protective layer 105 from adhering to the gasket material 101.

In some embodiments, the amount of releasing agent used on the gasket material surface 106 of the first protective layer 104 and the second protective layer 105 is different from the amount of releasing agent used on the densification tooling surface 107 of the first protective layer 104 and the second protective layer 105. Using different amounts of releasing agent for the different sides of the first protective layer 104 and the second protective layer 105 helps to ensure that the protective layers will adhere to the gasket material 101 during the densification process while also ensuring that the protective layers do not adhere to the densification tooling. Accordingly, in some embodiments, more releasing agent is used on the densification tooling surface 107 of the first protective layer 104 and the second protective layer 105 than on the gasket material surface 106 of the first protective layer 104 and the second protective layer 105.

In some embodiments, the first protective layer 104 and the second protective layer 105 are branded. The branding of the protective layers can take place before or after the protective layers are disposed on the first surface 102 and second surface 103 of the gasket material 101. In instances where the gasket material surface 106 of the first protective layer 104 or the second protective layer 105 is branded prior to being disposed on the gasket material 101, the material of the protective layers is preferably a transparent or suitably translucent material through which the branding can be seen once the protective layers are disposed on the gasket material 101. When the densification tooling surface 107 of the protective layers is branded, the protective layers do not need to be transparent or translucent. Any manner of branding the protective layers can be used, such as through the use of lasers or presses, and any type of information can be conveyed through the use of the branding, such as the material of the gasket material 101 or dates by which the gasket material 101 should be installed, replaced, or the like.

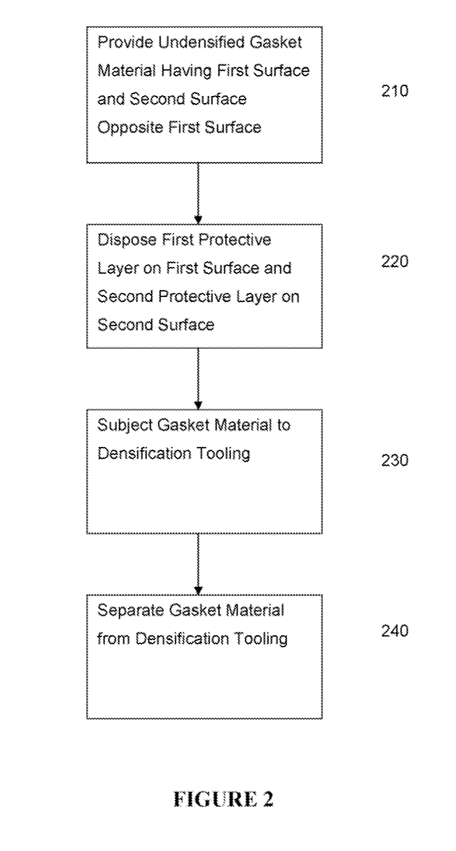

Processes for adhering protective layers to the gasket material also are disclosed herein. Referring to FIG. 2, the process generally includes the step 210 of providing an undensified gasket material having a first surface and a second surface opposite the first surface, a step 220 of disposing a first protective layer on the first surface and disposing a second protective layer on a second surface, a step 230 of subjecting the gasket material to densification tooling, and a step 240 of separating the gasket material from the densification tooling.

In step 210, an undensified gasket material is provided. The formation of many gasket materials typically includes a densification step where pressure and/or heat is applied to the gasket material in order to compress and compact the gasket material, including reducing the thickness of the gasket material. Densification can be achieved by various types of processes and using various types of tools. Exemplary tools that can be used for densification of gasket materials include, but are not limited to, molds, calendars, and press platens. Thus, in step 210, the gasket material provided has not yet undergone this densification step.

As indicated above, the gasket material provided in step 210 in an undensified state can be any suitable type of gasket material and can be in any of a variety of forms. In some embodiments, the gasket material is selected from any type of gasket material that typically undergoes densification as a part of manufacturing the gasket material. In some embodiments, the gasket material comprises graphite, compressed fibers, or a combination of the two. In some embodiments, the gasket material is provided as a sheet, although gasket material already cut to the desired shape and size can also be used.

Also as indicated above, the gasket material provided in step 210 includes a first surface and a second surface opposite the first surface. The two surfaces can be generally planar and aligned in parallel to one another. The distance between the two surfaces constitutes the thickness of the gasket material, and as discussed above, the thickness can by any suitable thickness required by end users for gasket materials.

In step 220, a first protective layer and a second protective layer are disposed on the first surface and the second surface, respectively. The protective layers may be similar or identical to the protective layers described in greater detail above. The protective layers can comprise various polymer materials that are not compromised when subjected to a densification step and can have various thicknesses. Typically, the thickness ranges from 0.001 inches to 0.020 inches. Also, as described in greater detail above, the first protective layer can be generally coextensive with the first surface and the second protective layer can be coextensive with the second surface, although protective layers that are smaller or greater than the surfaces of the gasket material also can be used.

As described in greater detail above, the first protective layer and the second protective layer can each have a gasket material surface and a densification tooling surface opposite the gasket material surface. In some embodiments, the first and second protective layers can be disposed on the gasket material such that the gasket material surface of the first protective layer faces the first surface of the gasket material and the gasket material surface of the second protective layer faces the second surface of the gasket material.

Additionally, in some embodiments, the protective layers disposed on the gasket material in step 220 are treated with releasing agent to thereby form releasing agent layers between the protective layers and the gasket material. The releasing agent can be similar or identical to the releasing agents described in greater detail above. In some embodiments, more releasing agent is used on the densification tooling surface of each protective layer than is used on the gasket material surface of each of the protective layers. The use of more releasing agent on the densification tooling surface of the protective layers can help to ensure that the protective layers do not adhere to the densification tooling used in steps described in greater detail below. At the same time, use of less releasing agent on the gasket material surfaces can help to ensure that the protective layers adhere to the gasket material after the gasket material is subjected to densification, but can still be peeled off of the gasket materials at a later time, such as prior to installation of the gasket material.

Any manner of disposing the protective layers on the gasket material can be used. In some embodiments, the protective layers are laid on the gasket material surfaces manually or using machinery adapted for this purpose. In some embodiments, the protective layers are first disposed on the densification tooling and are subsequently disposed on the gasket material once the densification tooling is applied to the gasket material. For example, when the densification tooling includes press platens, the protective layers can be disposed on the press platens prior to use of the press platens to densify the gasket material.

In step 230, the gasket material is subjected to densification tooling in order to densify the gasket material and move towards a finished gasket material product. Any suitable densification tooling can be used in step 230. As mentioned above, the densification tooling can comprise press platens. In some press platen configurations, the undensified gasket material is placed between press platens that come together and apply pressure to the gasket material. In such embodiments, the protective layers can be disposed on the gasket material prior to the press platens being brought together to densify the gasket material, or the protective layers can be disposed on the press platens. When the protective layers are disposed on the press platens, the protective layers are disposed on the gasket material as the press platens are brought together and contact the gasket material, followed by densifying the gasket material as the press platens continue to move together and apply pressure to the gasket material. Other exemplary densification tooling suitable for use in step 230 includes molds and calendars. As with the press platens, molds and calendars can also be used to both dispose the protective layers on the gasket material and to perform the densification step.

Upon completion of the densification step, the protective layers are releasably adhered to the gasket material Adherence of the protective layers to the gasket material following densification can be due to chemical and/or physical bonds between the protective layers and the gasket material. However, as described above, the presence of releasing agent on the protective layers will temper the bond between the gasket material and the protective layers so that the protective layers can still be removed from the gasket material.

In step 240, the gasket material is separated from the densification tooling. Any manner of separating the gasket material from the densification can be used, including manual or automated removal of the gasket material. In the example where press platens are used as the densification tooling in step 230, separation of the gasket material from the densification tooling can include separating the press platens and then removing the gasket material from in between the press platens.

While the protective layers releasably adhere to the gasket material as described above, the protective layers do not adhere to the densification tooling during the separation step 240. In some embodiments, this can be due to the additional releasing agent used on the densification tooling surface of the protective layers. Accordingly, as the gasket material is separated from the densification tooling in step 240, the protective layers remain with the gasket material and are not disrupted by any adherence to the densification tooling.

Upon completion of step 240, a coated gasket material similar or identical to the coated gasket material described in greater detail above is produced. The coated gasket material includes protective layers releasably adhered to both the first surface and the second surface of the gasket material. In view of the releasably adhered protective layers, some embodiments of the method described above will further include removing the first and/or second protective layer from the gasket material. One or both of the protective layers can be removed from the gasket material at any suitable time, including just prior to installation of the gasket material. In this manner, the protective layers can remain on the gasket material during transportation and cutting of the gasket material in order to prevent chipping and cracking of the gasket material, but can be discarded before installation rather than remain on the gasket during use.

Any manner of removing the protective layers from the gasket material can be used. In some embodiments, the protective layers can be manually peeled off of the gasket material.

In some embodiments, the method can also include a step of branding one or both of the protective layers. As discussed in greater detail above, the branding step can be performed prior to disposing the protective layers on the gasket material or after the protective layers have been disposed on the gasket material. Any suitable manner of branding the protective layers can be used, including those discussed above. Similarly, any type of information can be branded on the protective layers.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A process for adhering protective layers to a gasket material, the process comprising:
providing an undensified gasket material having a first surface and a second surface opposite the first surface;
disposing a first protective layer on the first surface and a second protective layer on the second surface;
subjecting the gasket material with the first protective layer and the second protective layer disposed thereon to densification tooling; and
separating the gasket material from the densification tooling.

2. The process as recited in claim 1, wherein the first protective layer adheres to the first surface and releases from the densification tooling when the gasket material is separated from the densification tooling and wherein the second protective layer adheres to the second surface and releases from the densification tooling when the gasket material is separated from the densification tooling.

3. The process as recited in claim 1, wherein the first protective layer and the second protective layer comprise polyethylene terephthalate (PET), polystyrene (PS), polyethelene polyethylene naphthalate (PEN), polycarbonate, or polyvinyl chloride.

4. The process as recited in claim 1, wherein the first protective layer and the second protective layer each comprises a gasket material surface and a densification tooling surface opposite the first surface, and wherein the disposing step further comprises disposing the first protective layer on the first surface such that the gasket material surface faces the first surface and disposing the second protective layer on the second surface such that the gasket material surface faces the second surface.

5. The process as recited in claim 4, further comprising treating the gasket material surface and the densification tooling surface of each of the first protective layer and the second protective with a releasing agent.

6. The process as recited in claim 5, wherein the treating step further comprises treating the densification tooling surface of first protective layer with more releasing agent than the gasket material surface of the first protective layer.

7. The process as recited in claim 5, wherein the treating step further comprises treating the densification tooling surface of second protective layer with more releasing agent than the gasket material surface of the second protective layer.

8. The process as recited in claim 5, wherein the releasing agent comprises a polymer releasing agent, a organic non-polymer releasing agent, or an inorganic non-polymer releasing agent.

9. The process as recited in claim 1, wherein the disposing step includes disposing the first protective layer and the second protective in a thickness in a range of from 0.001 inches to 0.020 inches.

10. The process as recited in claim 1, wherein the gasket material comprises a gasket material having a tensile strength lower than 2000 psi.

11. The process as recited in claim 1, further comprising removing the first protective layer and the second protective layer from the gasket material prior to using the gasket material.

12. The process as recited in claim 11, wherein the first protective layer and the second protective layer are removed from the gasket material by peeling the first protective layer and the second protective layer off the gasket material.

13. The process as recited in claim 1, further comprising branding the first protective layer, the second protective layer, or both the first and the second protective layer.

14. A protected gasket material comprising:
a gasket material having a first surface and a second surface opposite the first surface;
a first protective layer having a gasket material surface and a densification tooling surface opposite the gasket material surface, the first protective layer being disposed on the first surface such that the gasket material surface faces the first surface; and
a second protective layer having a gasket material surface and a densification tooling surface opposite the gasket material surface, the second protective layer being disposed on the second surface such that the gasket material surface faces the second surface;
wherein the gasket material surface and the densification tooling surface of the first protective layer are each treated with a releasing agent and the densification tooling surface is treated with more releasing agent than the gasket material surface; and
wherein the gasket material surface and the densification tooling surface of the second protective layer are each treated with a releasing agent and the densification tooling surface is treated with more releasing agent than the gasket material surface.

15. The coated gasket material as recited in claim 14, wherein the gasket material comprises graphite, compressed fiber, or a combination of the two.

16. The coated gasket material as recited in claim 15, wherein the first protective layer and the second protective layer each comprises polyethylene terephthalate (PET), polystyrene (PS), polyethelene polyethylene naphthalate (PEN), polycarbonate, or polyvinyl chloride.

17. The coated gasket material as recited in claim 15, wherein the releasing agent comprises a polymer releasing agent, an organic non-polymer releasing agent, or an inorganic non-polymer releasing agent.

18. The coated gasket material as recited in claim 15, wherein the first protective layer and the second protective layer each have a thickness in the range of from 0.001 inches to 0.020 inches.

19. The coated gasket material as recited in claim 15, wherein the first protective layer, the second protective layer, or both the first protective layer and the second protective layer are branded.

20. A protected gasket material comprising:
a gasket material comprising a first surface and a second surface opposite the first surface;
a first protective layer disposed on the first surface of the gasket material;
a second protective layer disposed on the second surface of the gasket material; and
means for releasably coupling the first protective layer to the first surface of the gasket material and for releasably coupling the second protective layer to the second surface of the gasket material.
